(19) United States
(12) Patent Application Publication
(10) Pub. No.: US 2013/0042603 A1
(43) Pub. Date: Feb. 21, 2013

(54) POWER GENERATION APPARATUS FOR CRYOGEN IN TRANSIT REFRIGERATION SYSTEM

(71) Applicant: Michael D. NEWMAN, Hillsborough, NJ (US)

(72) Inventor: Michael D. NEWMAN, Hillsborough, NJ (US)

(21) Appl. No.: 13/211,613

(22) Filed: Aug. 17, 2011

(51) Int. Cl. B60H 1/32; B60P 3/20

(52) U.S. Cl. 60/407; 62/245; 62/384

(57) ABSTRACT

A power generation apparatus for a heat exchanger exhausting pressurized gas includes an air circulation device for moving an air flow at a first atmosphere to contact the heat exchanger; a battery connected to the an air circulation device for providing electrical energy to power the air circulation device; a generator electrically connected to the battery to charge the battery with the electrical energy; a gas motor mechanically connected to the generator to drive the generator to provide the electrical energy; and a pipe connected to the heat exchanger for receiving the pressurized gas from the heat exchanger and directing said pressurized gas to the gas motor.

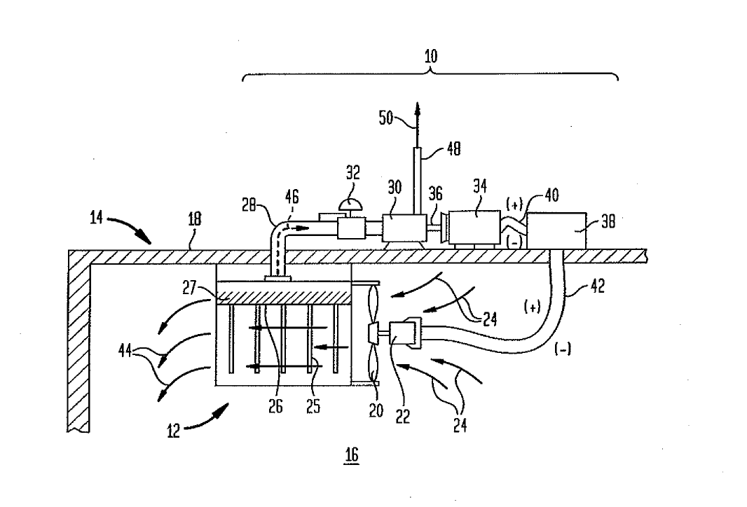

### BACKGROUND OF THE INVENTION

The present inventive embodiments relate to powering circulation fans used to move air across heat exchangers.

Known in-transit refrigeration (ITR) systems use fans to force warmer air from inside a freezing or chilling chamber across a heat exchanger. Such fans are powered or driven by battery power, thereby limiting their use for relatively short durations as the battery is discharged quickly in such an environment, even when the battery is remote from the freezing/chilling chamber. In other known systems, the battery may be recharged such as when the battery is powered off for example the delivery truck. However, battery recharging can only occur when the delivery truck motor is running so that the truck's battery is not unnecessarily drained when the truck motor is not in operation. These known power generation systems limit the operation of the fans which are necessary in order to provide for the heat exchange to freeze or chill the chamber.

### SUMMARY OF THE INVENTION

Therefore, it would be desirable to have the onboard battery to be recharged while the heat exchange system is being used, but not rely upon drawing power from the separate motor of the delivery truck. Such recharging is accomplished by using the exhaust gas from the heat exchange system which will provide the power necessary for the fans when needed, without relying upon the truck motor. In addition, the overall efficiency of the process and truck operation will increase as fuel to power the truck will no longer also be used to recharge the batteries of the truck or to power the battery for the heat exchange fans.

### BRIEF DESCRIPTION OF THE DRAWINGS

For a more complete understanding of the present embodiments, reference may be had to the following drawing FIGURE taken in conjunction with the description of the embodiments, of which:

The FIGURE discloses a power generation apparatus for cryogen in-transit refrigeration systems.

### DETAILED DESCRIPTION OF THE INVENTION

Referring to the FIGURE, a power generation system or apparatus of the present invention is shown generally at 10 for use with a heat exchanger 12 disposed in a housing 14 or compartment having a space 16 or chamber therein. The heat exchanger 12 is disposed in the space 16, most likely at an upper region of the space to cool or chill warmer air rising within the space. Freezing or chilling of products (not shown) such as for example food products is accomplished in the space 16. A side wall 18 of the space 16 may be insulated to maintain the reduced temperature in the space. The housing 14 may be mounted to a delivery truck or other in-transit refrigeration (ITR) system or vehicle, or the housing may be the rigid side wall of a delivery truck or ITR system. The term “vehicle” as used herein means any mechanized transport equipment such as a shipping container, truck, barge, etc.

A fan 20 or fans driven by a motor 22 is also disposed in the space 16 and operatively associated with the heat exchanger 12 to move the warmer air shown generally by the arrows 24 to contact fins 25 or coils of the heat exchanger 12.

The heat exchanger includes a snow bunker 26 or a pressure vessel in which a cryogen 27 such as for example CO₂ snow is contained. The cryogen can be loaded into the snow bunker or the pressure vessel in any known manner. The cryogen 27 can be loaded as a low pressure solid or in a higher pressure liquid state.

A pipe 28 or conduit is in communication with an interior of the pressure vessel 28 and extends to a gas motor 30. A back pressure regulator 32 is in communication with the pipe 28 and operably associated with the gas motor 30. The gas motor 30 is mechanically connected to a generator 34, such as by a shaft 36. The generator 34 is electrically connected to a battery 38 by electrical leads 40 or wiring. The battery 38 is connected to the fan motor 22 by electrical leads 42 or wiring.

In operation, the warmer air 24 in the space 16 is moved by the fan 20 across the fins 25 of the heat exchanger 12, whereupon heat exchange occurs so that a chilled or frozen air flow shown generally by arrows 44 is reintroduced into the space 16. The cryogen (CO₂ snow, for example) in the bunker 26 of the heat exchanger 12 sublimes under the heat exchange occurring when heat is transferred into the cryogen from the warm internal air of the space 16, such that a high pressure gas 46 is exhausted from the bunker 26 through the pipe 28 and into the gas motor 30. The back pressure regulator 32 monitors pressure in the bunker 26 and releases a necessary amount of the high pressure gas 46 from the bunker 26 to be introduced into and travel along the pipe 28 to the gas motor 30. The regulator 32 therefore provides for a uniform, consistent flow of the gas 46 to the gas motor 32. The pressurized gas 46 powers the gas motor 30, which in turn by the shaft 36 drives the generator 34. The generator 34 creates electrical energy which is transmitted to and recharges the battery 38. The battery 38 as mentioned above is electrically connected to the fan motor 22 to drive the fan 20. Unused gas at the motor 30 can be exhausted through a vent 48 as indicated by arrow 50.

The result of the power generation apparatus 10 is that regardless of whether the ITR truck engine (not shown) is or is not running, as long as heat exchange is occurring and the pressurized gas flow 46 is available, there will be electrical energy generated to recharge the battery 38 and therefore power the fans 20 to continue with the heat exchange of the atmosphere in the compartment 14.

An alternative embodiment calls for the bunker 26 to instead contain nitrogen (N₂) instead of CO₂ snow. If nitrogen is used as the cryogen for the heat exchanger 12, then a pressure vessel would be used instead of the CO₂ bunker.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A power generation apparatus for a heat exchanger exhausting pressurized gas, comprising:
an air circulation device for moving an air flow at a first atmosphere to contact the heat exchanger;
a battery connected to the air circulation device for providing electrical energy to power the air circulation device;
a generator electrically connected to the battery to charge the battery with the electrical energy;
a gas motor mechanically connected to the generator to drive the generator to provide the electrical energy; and
a pipe connected to the heat exchanger for receiving the pressurized gas from the heat exchanger and directing said pressurized gas to the gas motor.

2. The power generation apparatus of claim 1, further comprising a pressure regulator in communication with the pressurized gas in the pipe to regulate an amount of said pressurized gas in the pipe delivered to the gas motor.

3. The power generation apparatus of claim 1, wherein said battery, generator and gas motor are disposed in a second atmosphere remote from the first atmosphere.

4. The power generation apparatus of claim 3, wherein the pipe extends between the first and second atmospheres.

5. The power generation apparatus of claim 1, wherein the first atmosphere is contained in a space of a container.

6. The power generation apparatus of claim 5, wherein the container is mounted to an in-transit refrigeration vehicle.

7. The power generation apparatus of claim 1, further comprising a vent pipe connected to the gas motor for venting an unused portion of the pressurized gas from the gas motor.

8. The power generation apparatus of claim 1, wherein the air circulation device comprises at least one fan.
